(19) United States
(12) Patent Application Publication
(10) Pub. No.: US 2002/0088657 A1
(43) Pub. Date: Jul. 11, 2002

(54) Method and apparatus for motorizing a wheelchair

(76) Inventors: Vincent Brett, Rockville Centre, NY (US); Dave Jones, East Meadow, NY (US)

Correspondence Address: Vincent Brett, 75 Liberty Avenue, Rockville Centre, NY, 11570, US

(21) Appl. No.: 09/759,814

(22) Filed: Jan. 11, 2001

(51) Int. Cl. B60R 16/04

(52) U.S. Cl. 180/68.5

(57) ABSTRACT

A steering mechanism for a wheelchair, consisting of a steering wheel affixed to a shaft, engaging a caster wheel via shaft bearing and adapter to allow the user to better control the direction in which the wheelchair is moving. The steering wheel is positioned parallel to the ground to allow for steering with relative ease. The steering wheel can be placed on either the right or left side of the chair and can be removed to allow the wheelchair to fit through narrow doorways. The assembly extends several inches outwardly from the wheelchair, to avoid interference with leg extensions and to avoid impediments to collapsibility of the chair.

### BACKGROUND OF THE INVENTION

1. Field of the Invention

The present invention is a method and apparatus for motorizing a wheelchair. More particularly, the present invention is an assembly, detachably affixed to a conventional wheelchair, that primarily consists of a fifth ground-engaging wheel, a power means, and linkage means to the both body of the wheelchair and at least one user control device. The fifth wheel is intended to be placed towards the rear of the wheelchair, positioned between each of the previously existing rear wheels. In the preferred mode, a at least one battery pack is positioned upon a small flat surface which functions as a platform for the fifth powered wheel. Such battery pack and power means function to provide greater traction and stability for the drive wheel, due to the additional weight of same upon the platform. Such platform is conveniently affixed to two previously-existing rods which extend outwardly from the rear frame of the conventional wheelchair, with extensions from the platform snapped thereto. As such, the detachable power assembly is easily retrofittable to a conventional wheelchair in a manner that easy to disassemble for storage, during periods where manual power is sufficient.

2. Description of the Prior Art

Numerous innovations for motorizing attachments and devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 5,494,126, invented by Meeker, entitled “Apparatus And Method For Attaching A Motorized Wheel To A Wheelchair”

The patent to Meeker describes an apparatus and method for attaching a motorized wheel to a wheelchair including a mounting frame operatively connected to the motorized wheel, the frame having a laterally-extending cylindrical member, and a mounting bracket operatively connected to a frame of the wheelchair, the bracket having an open slot for receiving the cylindrical member of the mounting frame, the slot defining an interior cam surface which is open on the front side thereof and enclosed on the bottom, back and top sides thereof. The frame has means for adjusting the width thereof to accommodate a variety of different wheelchairs. The mounting frame has a second laterally-extending cylindrical member which is a slidable pin for selective engagement with the mounting bracket to attach the motorized wheel to the wheelchair.

2. U.S. Pat. No. 5,050,695, invented by Kleinwolterink, entitled “Power Attachment For Wheelchair”

The patent to Kleinwolterink describes a powered unit for adding motive power to a wheelchair comprising a frame adapted for easy attachment to the chair and steerable motive means powered preferably by an electric motor and including a wheel adapted to pull and to steer the chair.

3. U.S. Pat. No. 5,350,032, invented by Smith, entitled “Power Conversion Kit For Wheelchair”

The patent to Smith is a kit for power conversion of a manually powered wheelchair is provided wherein one or more power hubs are integrated into the rear drive wheels of such chair to effect propulsion thereof by means of a simple controller mounted to the armrest of the chair. This power conversion kit is unique in several respects in that it mounts to the existing frame of a wheelchair of “standard” design at the same location and through the same holes provided for mounting of the original rear wheels. Moreover, the conversion kit is further provided with a supporting fixture for the powered rear wheels which is designed to both (a) maintain the original clearances of the manually powered chair (so as not to subject the occupant to any inconvenience or distress in its operation) and (b) effectively shift the center of balance of the chair to enhance its stability during powered operation. This fixture has three defined area or segments; a first (coupling) segment which mounts directly to the chair frame at the same location and through the same holes of the support for the rear wheels which it replaces; a second (offsetting) segment which connects the first segment to the third segment (motor support); and, the third segment provides a stator for the power drive assembly to which the rear wheel is supported and driven. The second or transitional segment is unique by design in that it effectively positions the power drive assembly inboard so as to maintain the width of the chair, as thus modified, essentially the same as the manually powered chair, while insuring enhanced stability by increasing the chairs forward weight distribution during powered operation.

4. U.S. Pat. No. 4,386,672, invented by Coker, entitled “Detachable Electric Drive Unit For Wheelchair”

The patent to Coker describes a battery powered steerable electric drive unit for detachable connection to a conventional wheelchair comprises: a framework releasably connectable to the wheelchair frame by snap-on connectors; a drive assembly pivotably (steerably) mounted on the framework and including a ground-engaging wheel and battery-powered electric motor for driving the wheel; a detachable steering column pivotably and rotatably mounted on the framework and operatively connected to the drive assembly to effect steering when rotated about its longitudinal axis; a handle mounted transversley on the steering column and rotatable in opposite directions to various positions about its horizontal longitudinal axis; and an electric controller including switches responsive to handle rotation to control the direction and speed of motor rotation.

5. U.S. Pat. No. 5,826,670, invented by Nan, entitled “Detachable Propulsive Device For Wheelchair”

The patent to Nan describes a detachable propulsive device for a wheelchair includes a longitudinal skeleton frame, a driving unit attached to the front of the skeleton frame, a handle for steering the propulsive device, dimensions adjusting unit, and auxiliary wheels. The dimensions adjusting unit carries four retaining clips and allows to adjust distances between these clips lengthwise and widthwise, so that the clips are capable of engaging and holding side members of the bottom frame of the wheelchair of any desired length and width. The length adjusting mechanism of the dimensions adjusting unit includes a system of telescopically movable hollow tubes with U-shaped cross sliding rails secured to them, while the width adjusting mechanism includes sliding arms carrying the retaining clips on their outer ends and sliding longitudinally along the U-shaped cross sliding rails in the lateral direction. The auxiliary wheels at the rear of the propulsive device are lifted from the ground once the device has been attached to the wheelchair.

6. U.S. Pat. No. 5,135,063, invented by Kropf, entitled “Power Unit For Driving Manually Operated Wheelchair”

The Kropf invention relates to a power drive unit which is attachable to, and detachable from, a conventional wheelchair. Thus, a conventional manually-powered wheelchair can be converted into a power driven wheelchair employing the subject apparatus for driving and directing the movement of a manually-driven wheelchair having a plurality of wheels riding on an underlying surface. The subject apparatus comprises a drive and steering wheel which rides on the underlying surface for driving and for directing the path of operation of the wheelchair, as well as for powering the drive wheel. The apparatus is attachable to, and detachable from the wheelchair and is located rearwardly of the wheelchair so that the weight on the drive and steering wheel will substantially only be the weight of the apparatus. On the other hand, the weight of a person sitting in the wheelchair will be substantially the only weight imparted to the wheelchair wheels. The power steering and driving operations are continuously conducted using the drive wheels, without regard to substantial direct downward forces imparted to the drive wheels by the wheelchair user. The unit preferably comprises a single rear-wheel drive motor and wheel unit.

7. U.S. Pat. No. 4,503,925, invented by Palmer et al., entitled “Detachable Steerable Power Unit For Occupant Propelled Wheelchairs”

The patent to Palmer, et al. describe a steerable motorized power unit constructed for detachable coupling to a conventional occupant propelled wheelchair in a manner such that it can be easily and conveniently coupled to, or uncoupled from, the chair by the occupant. Coupling pins are provided with plates which can be fixedly clamped to the tubular chair frame at a selected position without requiring any modification to the frame and without interfering with the normal operation of the chair.

8. U.S. Pat. No. 5,186,269, invented by Avakian et al., entitled “Method Of And Apparatus For Motorizing Manually Powered Vehicles”

The patent to Avakian et al. describes an apparatus which enables a foldable wheelchair to be retrofitted with an electrical propulsion system without significantly compromising the ability to fold the chair. The apparatus includes a drive unit for each wheel to be driven. The drive units can be mounted on the stationary axles of the driven wheels and apply torque, generated by a separate motor in each drive unit, to the wheels at a plurality of symmetrically located points which are radially displaced from the axles.

9. U.S. Pat. No. 4,961,473, invented by Jones, entitled “Kit For Converting A Hand Powered Wheelchair To An Electric Motor Power Wheelchair”

The patent to Jones describes a kit for converting a hand-powered wheelchair to an electric motor-powered wheelchair is disclosed. The kit includes a pair of DC electric motors, each motor being connected to a drive wheel for rotating the drive wheel. The motors are mounted on the supporting frame of the chair for pivotal movement relative to the frame between a first position with the drive wheel adjacent to but spaced from the rim of one of the large diameter rear wheels of the chair and a second position with the drive wheels in engagement with the wheels so that rotation of the drive wheels will rotate the large wheels and move the chair. Levers are mounted on the frame for moving the motors between the first and second positions. A battery supplies power to the motors through switches that control the flow of electricity to the motors.

In contrast to the above, the present invention is an assembly, detachably affixed to a wheelchair, consisting of a fifth wheel, power means, and linkage to the chair body and user control(s). The fifth wheel is placed towards the rear of the chair, positioned between each of the previously-existing rear wheels. Positioning of the drive wheel towards the rear, rather than between the occupant's feet, keeps the drive wheel from obstructing the occupant's movement. At least one battery pack is placed upon a flat surface which functions as a platform for the drive wheel. The battery pack and power means provide greater traction for the drive wheel, due to additional weight thereon. The platform is affixed to previously-existing rods extending outwardly from the rear of the chair, with platform extensions snapped thereto. As such, the assembly is retrofittable to a conventional wheelchair in a manner that easy to detach for storage.

Regarding the most relevant prior art, U.S. Pat. No. 5,494,126 by Meeker describes an apparatus including a mounting frame connected to a motorized wheel, the frame having a laterally-extending cylindrical member, and mounting bracket connected to a wheelchair frame, the bracket having an open slot for receiving the cylindrical member, the slot defining an interior cam surface which is open on the front side and enclosed on the bottom, back and top sides. The frame has width adjusting means to accommodate a variety of wheelchairs. The mounting frame has a second cylindrical pin for engagement with the bracket to attach the motorized wheel to the wheelchair.

In general, like the Meeker patent, the present invention is an assembly for converting a standard wheelchair to a power-driven device. Both inventions feature an additional powered wheel removably affixed to the chair by a mounting member, and the additional wheel in both inventions lies in the center of the existing left and right wheels. However, the Meeker patent fails to specifically teach the usage of a fifth wheel placed towards the rear of the wheelchair, positioned between each of the previously existing rear wheels. The positioning of the drive wheel towards the rear of the chair, rather than between the occupant's legs or feet, keeps the drive wheel from obstructing the occupant s movement. Moreover, due to its unique attachment means, the detachable power assembly of the present invention is also more easily retrofittable to a conventional wheelchair in a manner that easy to disassemble for storage, during periods where manual power is sufficient.

In addition, U.S. Pat. No. 5,050,695 by Kleinwolterink describes a powered unit for adding motive power to a wheelchair comprising a frame adapted for easy attachment to the chair and steerable motive means powered preferably by an electric motor and including a wheel adapted to pull and to steer the chair.

The patent to Kleinwolterink is also conceptually similar to the present invention, in that the same includes a device and method for powering a conventional wheelchair. The Kleinwolterink device also relies upon a small, lightweight motor in an assembly that is easy to attach and detach from a wheelchair at the center portion thereof. However, the Kleinwolterink patent, like the Meeker patent, fails to teach the usage of the drive wheel in the rear of the chair, between each of the conventional rear wheels, preventing the drive wheel from obstructing user movement. In fact, the Kleinwolterink patent specifically claims “a motorizing unit having means engaged with said chair frame to raise and support said front wheels.”

### SUMMARY OF THE INVENTION

As noted above, the present invention is a method and apparatus for motorizing a wheelchair. More particularly, the present invention is an assembly, detachably affixed to a conventional wheelchair, that primarily consists of a fifth ground-engaging wheel, a power means, and linkage means to the both body of the wheelchair and at least one user control device. The fifth wheel is intended to be placed towards the rear of the wheelchair, positioned between each of the previously existing rear wheels. In the preferred mode, a at least one battery pack is positioned upon a small flat surface which functions as a platform for the fifth powered wheel. Such battery pack and power means function to provide greater traction and stability for the drive wheel, due to the additional weight of same upon the platform. Such platform is conveniently affixed to two previously-existing rods which extend outwardly from the rear frame of the conventional wheelchair, with extensions from the platform snapped thereto. As such, the detachable power assembly is easily retrofittable to a conventional wheelchair in a manner that easy to disassemble for storage, during periods where manual power is sufficient.

In light of the foregoing, it is an object of the invention to provide a power assembly that is removable from the wheelchair and generally convenient to install and operate.

It is also an object of the present invention to teach the usage of a power assembly that is generally safe for the user to operate.

It is a further object to provide a power assembly that may be easily retrofitted to previously-existing wheelchairs, providing the benefits of the present invention to all wheelchair users.

In addition, it is an object of the present invention to provide a power assembly that may alternatively be manufactured on new wheelchairs for users who desire the benefits thereof on later models.

It is an objective of the invention to allow the wheelchair to function as a true hybrid between a manual device and powered device, achieving the utmost in versatility for the user, and dispensing with the requirement for the user to maintain two separate wheelchairs.

An additional aim of the invention is to provide an effective power means that may be produced at substantially low costs.

Similarly, it is a goal of the present invention to allow the device to be manufactured with relative ease.

Another goal of the invention is to provide a detachable power means that is sufficiently light in weight as to allow substantially any person to affix the same to the wheelchair.

Regarding the above, it is a goal of the invention to provide a power means that may be conveniently wheeled across a flat surface and affixed to the wheelchair without the need for significant lifting or bending.

Still another object of the present invention is to provide a removable power means with strong traction to facilitate driving of the wheelchair to which it is affixed.

Another important object of the apparatus is to provide a power means with a drive wheel located towards the rear of the assembly, functioning to clear such wheel from the user's feet for the purposes of safety, convenience, and enhanced traction.

An additional aim of the invention is to provide a power assembly that offers various speed controls to the user, for the purpose of versatility and ease of operation.

Another aim of the invention is to provide a power attachment that itself may comprise multiple batteries, such as to ensure that the user may mobilize the wheelchair, even in the event of primary battery power loss or failure.

The novel features which are considered characteristic for the invention are set forth in the appended claims. The invention itself, however, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

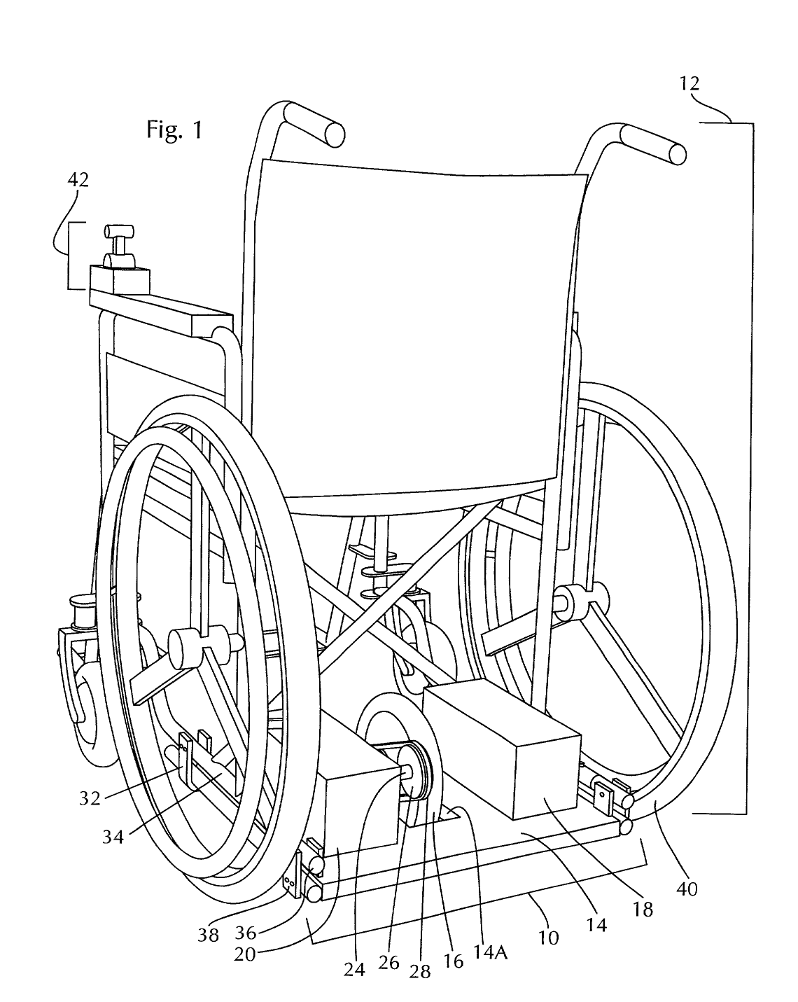

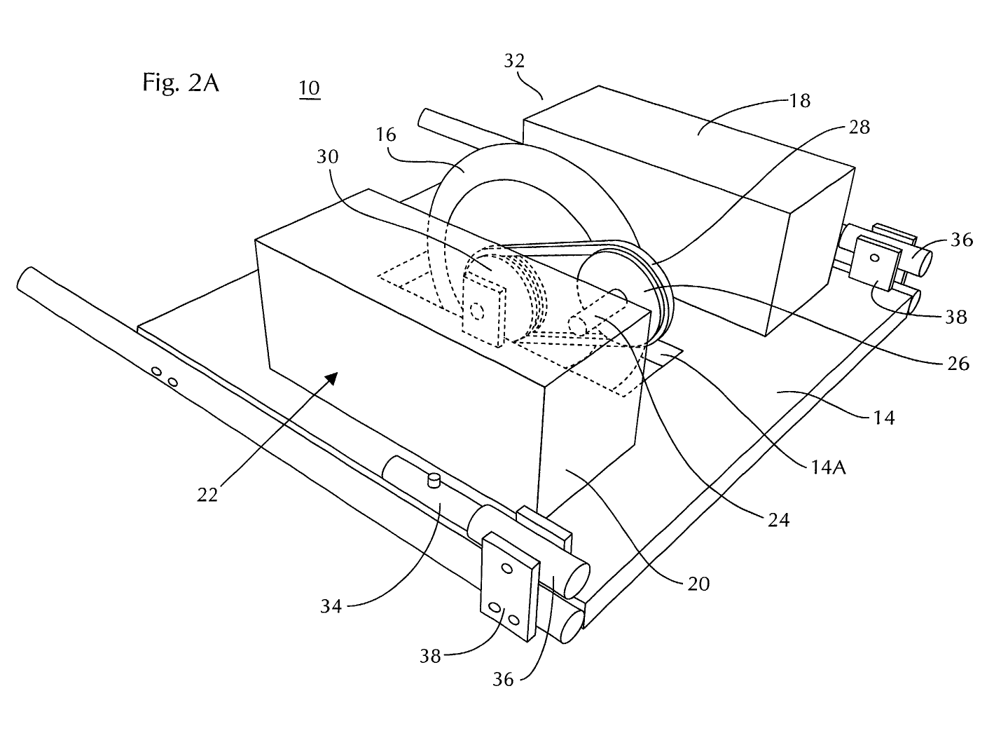

FIG. 1 is a three-quarter side perspective view of the primary embodiment of the apparatus for motorizing a wheelchair, with the full apparatus affixed to the rear of the previously-existing wheelchair, illustrating all principal components thereof.

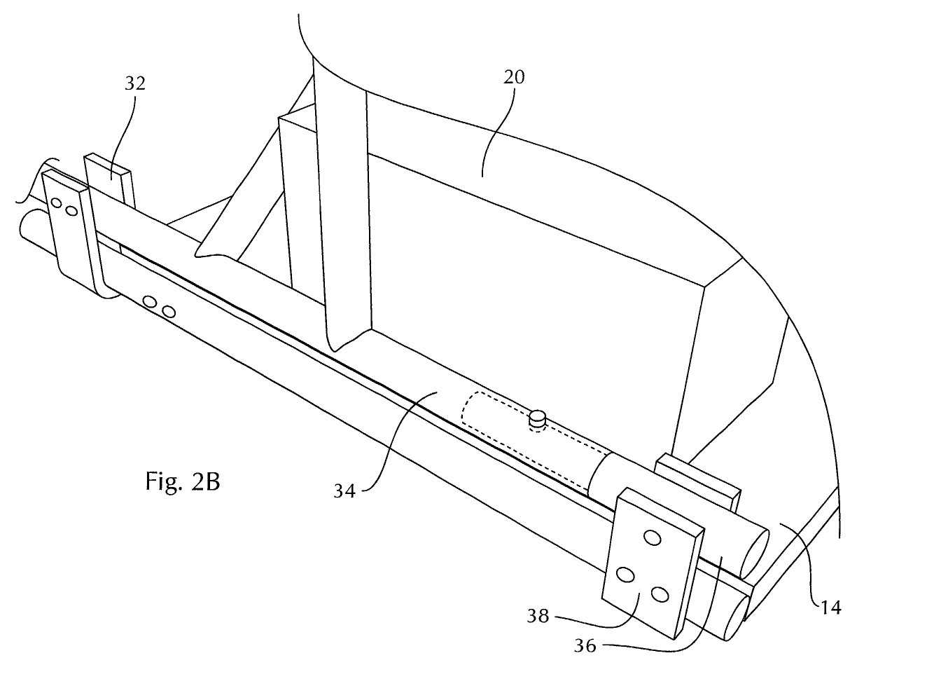

FIG. 2A is a three-quarter side perspective view of the apparatus for motorizing a wheelchair, standing alone and apart from the wheelchair.

FIG. 2B is a close-up, three-quarter side perspective view of the apparatus for motorizing a wheelchair, standing alone and apart from the wheelchair, illustrating the means of attachment to previously-existing wheelchair cylindrical rods.

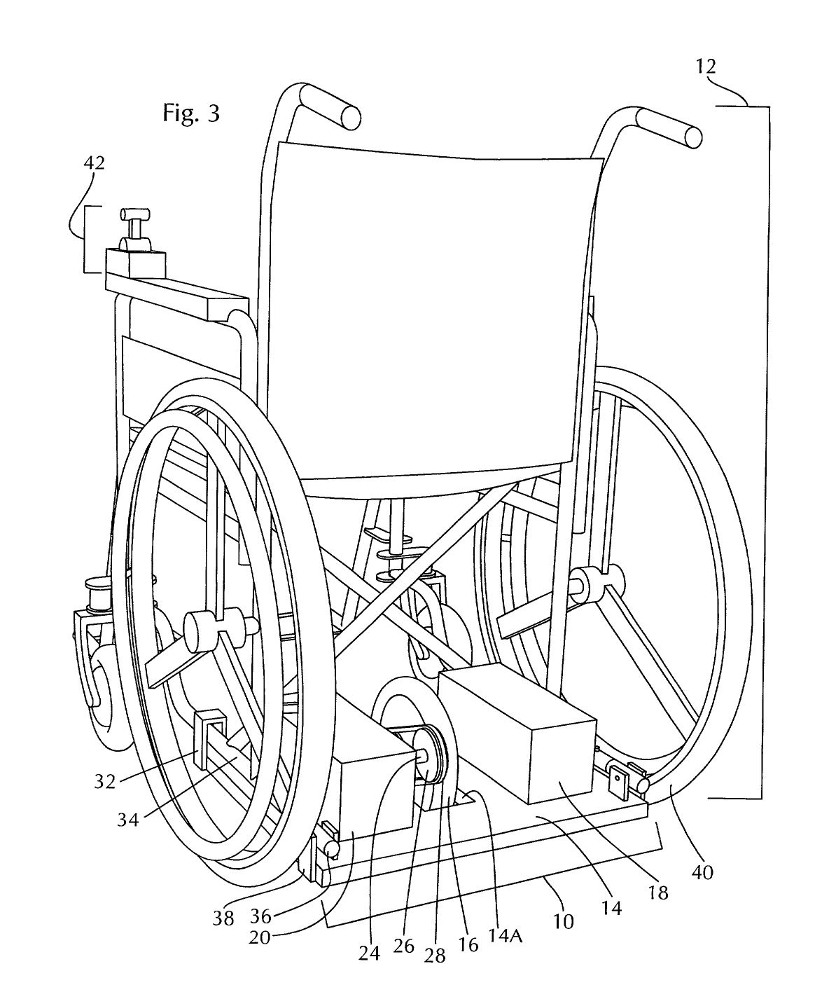

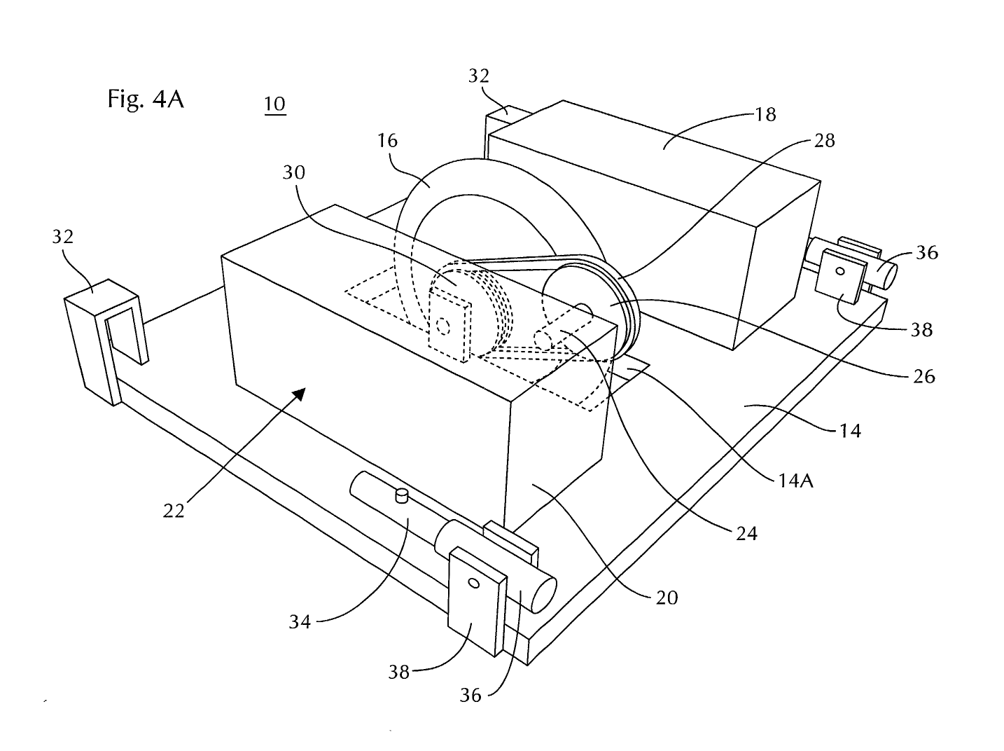

FIG. 3 is a three-quarter side perspective view of an additional embodiment of the apparatus for motorizing a wheelchair, with the fall apparatus affixed to the rear of the previously-existing wheelchair, illustrating all principal components thereof.

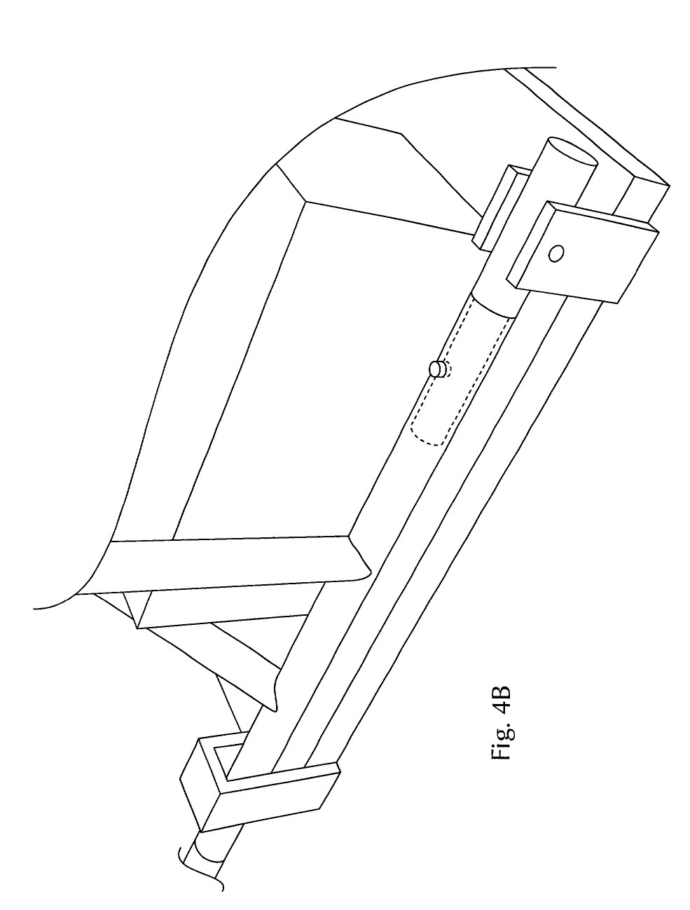

FIG. 4A is a three-quarter side perspective view of an additional embodiment of the apparatus for motorizing a wheelchair, standing alone and apart from the wheelchair.

FIG. 4B is a close-up, three-quarter side perspective view of an additional embodiment of the apparatus for motorizing a wheelchair, standing alone and apart from the wheelchair, illustrating the means of attachment to previously-existing wheelchair cylindrical rods.

### DETAILED DESCRIPTION OF THE PREFERRED EMBODIMENT

As illustrated in the above-referenced figures, an apparatus (10) for motorizing a wheelchair (12) comprises a generally rectangular solid platform (14), which comprises a platform aperture (14A) located at a generally center portion thereof. Generally, the platform may manufactured of a material selected from the group consisting of wood, metal, plastic, and plastic composite. A drive wheel (16) extends downwardly through the platform aperture (14A), the drive wheel (16) functioning to come in contact with a ground surface beneath the platform. The drive wheel may manufactured in a variety of sizes, as desired, such as a diameter in the size range of four inches to twelve inches.

The platform (14) further comprises at least one battery compartment (18) thereon, the battery compartment (18) comprising at least one battery therein. The at least one battery functions to provide power to a motor (22) located within a motor housing (20) upon the platform (14). The motor (22) is engaged by the user through usage of a hand control means (42), much in the traditional sense. As such, the hand control means may be a steering wheel, for user comfort and familiarity, or may, in the alternative, be a lever or stick-type member.

To further describe the drive mechanism utilized by the present invention in the preferred mode, a shaft (24) extends outwardly from the motor (22) and motor housing (20). The shaft (24), in turn, engages a generally elliptical rotor (26). A pulley member (28) extends around a periphery of the rotor (26), with a distal end of the pulley member (28) extending around a periphery of a hub member (30). The hub member (30) is rigidly affixed to the drive wheel (16). Thus, power to the motor (22) results in engagement of such drive wheel (16).

Furthermore, the platform (14) is removably affixed to a plurality of pre-existing wheelchair cylindrical rods (34), which are located at a rear portion of a standard wheelchair. Such is particularly attached through insertion of a plurality of receiving cylindrical members (36), which are rigidly affixed to the platform (14), and correspond to the pre-existing cylindrical rods in shape and configuration. The receiving cylindrical members (36) extend along the left and right sides of the platform (14), respectively.

The apparatus further utilizes both a front attachment means (32) and rear support means (38) to provide additional support thereto. Specifically, the front attachment means (32) comprises a solid, curved, open-ended member which functions to secure platform (14) to pre-existing wheelchair cylindrical rods (34), in the preferred mode, as shown in FIGS. 1, 2A, and 2B. In an alternate embodiment, the front attachment means (32) comprises a solid, squared, open-ended member which also functions to secure platform (14) to pre-existing wheelchair cylindrical rods (34), as shown in FIGS. 3, 4A, and 4B.

The aforementioned rear support means (38) comprises a solid, generally flat member which further functions to secure platform (14) to receiving cylindrical members (36), for the purposes of strong attachment of the removable apparatus.

In total, then, the apparatus (10) for motorizing a wheelchair (12) is used in conjunction with pre-existing wheels (40) to drive the wheelchair (12) as desired by a user. As noted in the “Summary” section herein, the apparatus may be retrofitted to previously-existing wheelchairs, or, alternatively, may be manufactured in connection with new model wheelchairs. Thus, the utility and convenience of the present invention will be fully available to all persons in need of the same. It is important to note that the apparatus does not interfere with collapsibility of the wheelchair, as such may be easily removed from the chair.

Regarding additional options afforded by the present invention, the added drive wheel may manufactured in a variety of diameter sizes, such as to allow manufacturers and users to select an appropriately sized wheel for all intended applications.

In addition, the apparatus is fully removable from the wheelchair, such as to allow the user to operate the wheelchair manually, if desired.

Moreover, in enhanced embodiment, the battery compartment may comprise a plurality of batteries, which will function to provide a significant backup power means in the event of decrease in primary battery power. Thus, the user of such an embodiment need not worry about the level of strength of the primary battery, especially in the event that the user is unable to mobilize the wheelchair manually due to his or her physical condition.

In still a further enhanced embodiment of the present invention, the motor may be configured upon a wheel directly, in a manner that would directly engage the same in order to mobilize the wheelchair. Such mechanism, previously utilized on such items as motorized bicycles, would be quite effective for the purposes sought by the present invention.

With regard to any embodiment noted above, as noted, the assembly described herein may be retrofitted to previously existing wheelchairs, or alternatively may be manufactured in connection with new model wheelchairs.

With regards to all FIGURES, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. An apparatus (10) for motorizing a wheelchair (12) comprising:
a generally rectangular solid platform (14) comprising a platform aperture (14A) located at a generally center portion thereof,
a drive wheel (16) extending downwardly through the platform aperture (14A), the drive wheel (16) functioning to come in contact with a ground surface,
the platform (14) further comprising at least one battery compartment (18) thereon, the battery compartment (18) comprising at least one battery therein, the at least one battery functioning to provide power to a motor (22) located within a motor housing (20) upon the platform (14), motor (22) engaged by usage of a hand control means (42),
a shaft (24) extends outwardly from the motor (22) and motor housing (20), the shaft (24) engaging a rotor (26),
a pulley member (28) extends around a periphery of the rotor (26), a distal end of the pulley member (28) extending around a periphery of a hub member (30), the hub member (30) rigidly affixed to the drive wheel (16), such that power to the motor (22) results in engagement of drive wheel (16),
the platform (14) removably affixed to a plurality of pre-existing wheelchair cylindrical rods (34) located at a rear portion of a wheelchair through insertion of a corresponding plurality of receiving cylindrical members (36) rigidly affixed to the platform (14) and extending along the left and right sides of the platform (14),
the apparatus further utilizing front attachment means (32) and rear support means (38) to provide additional support thereto, front attachment means (32) comprising a solid, curved, open-ended member which functions to secure platform (14) to pre-existing wheelchair cylindrical rods (34), rear support means (38) comprising a solid member which functions to secure platform (14) to of receiving cylindrical members (36),
the apparatus (10) for motorizing a wheelchair (12) used in conjunction with pre-existing wheels (40) to drive the wheelchair (12) as desired by a user.

2. The apparatus for motorizing a wheelchair as described in claim 1, wherein the apparatus may be retrofitted to previously-existing wheelchairs.

3. The apparatus for motorizing a wheelchair as described in claim 1, wherein the assembly may be manufactured in connection with new model wheelchairs.

4. The apparatus for motorizing a wheelchair as described in claim 1, wherein the wheel is manufactured in a variety of diameter sizes, such as to allow users to select an appropriately sized wheel.

5. The apparatus for motorizing a wheelchair as described in claim 1, wherein the apparatus is removable from the assembly, such as to allow the user to operate the wheelchair manually.

6. The apparatus for motorizing a wheelchair as described in claim 1, wherein the battery compartment comprises a plurality of batteries, functioning to provide a backup power means in the event of decrease in primary battery power.

7. The apparatus for motorizing a wheelchair as described in claim 1, wherein the user hand control is a steering wheel.

8. The apparatus for motorizing a wheelchair as described in claim 1, wherein the user hand control is a lever member.

9. The apparatus for motorizing a wheelchair as described in claim 1, wherein a motor is configured upon and directly linked to the drive wheel.

10. The apparatus for motorizing a wheelchair as described in claim 1, wherein the platform is manufactured of a material selected from the group consisting of wood, metal, plastic, and plastic composite.

11. The apparatus for motorizing a wheelchair as described in claim 1, wherein the drive wheel is manufactured of a diameter in the size range of four inches to twelve inches.

12. The apparatus for motorizing a wheelchair as described in claim 1, wherein the apparatus does not interfere with collapsibility of the wheelchair, as such may be easily removed from the wheelchair.
